(19) United States
(12) Patent Application Publication
(10) Pub. No.: US 2017/0132208 A1
(43) Pub. Date: May 11, 2017

(54) PERSONALIZED PARAPHRASING FOR READING IMPROVEMENT

(71) Applicant: International Business Machines Corporation, Armonk, NY (US)

(72) Inventors: Venkat A. R. Adavelli, Hyderabad (IN); Sivakumar Avkd, Visakhapatnam (IN); Sri Harsha Varada, Vizianagaram (IN)

(21) Appl. No.: 14/934,202

(22) Filed: Nov. 6, 2015

(51) Int. Cl. G06F 17/27; G06F 17/24

(52) U.S. Cl. CPC G06F 17/2735; G06F 17/24

(57) ABSTRACT

In an approach to paraphrasing text, a computing device receives text as viewed by a user. The computing device determines whether a personalized dictionary is available, where the personalized dictionary includes a writing history of the first user. In response to determining the personalized dictionary is available, the computing device retrieves the personalized dictionary. The computing device determines, based, at least in part, on the personalized dictionary, whether the first user prefers paraphrasing of the received text. In response to determining the first user prefers paraphrasing of the received text, the computing device determines paraphrased text based on contents of the personalized dictionary. The computing device displays the paraphrased text to the first user.

### BACKGROUND OF THE INVENTION

The present invention relates generally to the field of document processing, and more particularly to personalized paraphrasing for reading improvement.

Electronic books and other digital content offer a wide variety of content to readers using electronic devices. A reader's ability to comprehend a digital content document and the speed at which a reader can read the document are dependent on a plurality of factors, including the size of the reader's vocabulary, the reader's native language or fluency in the language in which the document is written, and influences of the reader's culture or geographic location.

A paraphrase is a restatement of the meaning of a text or passage using other words. A paraphrase typically explains or clarifies the text that is being paraphrased. A paraphrase may attempt to preserve the essential meaning of the material being paraphrased. The phrase “in your own words” is often used within this context to imply that the writer has rewritten the text in their own writing style, i.e., the manner in which the writer would have written the text if the writer had created the content. Nowadays, there are some models to learn and recognize paraphrase on natural language texts.

### SUMMARY

Embodiments of the present invention disclose a method, a computer program product, and a system for paraphrasing text. The method may include a computing device receiving text as viewed by a user. The computing device determines whether a personalized dictionary is available, where the personalized dictionary includes a writing history of the first user. In response to determining the personalized dictionary is available, the computing device retrieves the personalized dictionary. The computing device determines, based, at least in part, on the personalized dictionary, whether the first user prefers paraphrasing of the received text. In response to determining the first user prefers paraphrasing of the received text, the computing device determines paraphrased text based on contents of the personalized dictionary. The computing device displays the paraphrased text to the first user.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a paraphrasing program, on a server computer within the distributed data processing environment of FIG. 1, for personalized paraphrasing of text, in accordance with an embodiment of the present invention; and

FIG. 3 depicts a block diagram of components of the server computer executing the paraphrasing program within the distributed data processing environment of FIG. 1, in accordance with an embodiment of the present invention.

### DETAILED DESCRIPTION

There exists a plurality of digital documents written in varying styles and languages. Authors may use many different styles, word selections, and sentence patterns to get a point across or provide a description. Readers of the digital documents may have varying levels of education, come from different backgrounds, or speak a different language than the author. Some readers may therefore find discomfort reading documents that are somewhat different in style than the reader prefers. The reader may not be acquainted with words used by the author. The reader may not be comfortable with the author's choice of sentence formation. The reader may not know the language the author uses. Embodiments of the present invention recognize that improvements to a reader's comfort and comprehension can be gained by paraphrasing a text based on the reader's preferred writing style, thereby increasing the reader's understanding and the speed at which the reader can read the text. Embodiments of the present invention also recognize that efficiency may be gained by using an apparatus that presents paraphrased text in a reader's field of view. Implementation of embodiments of the invention may take a variety of forms, and exemplary implementation details are discussed subsequently with reference to the Figures.

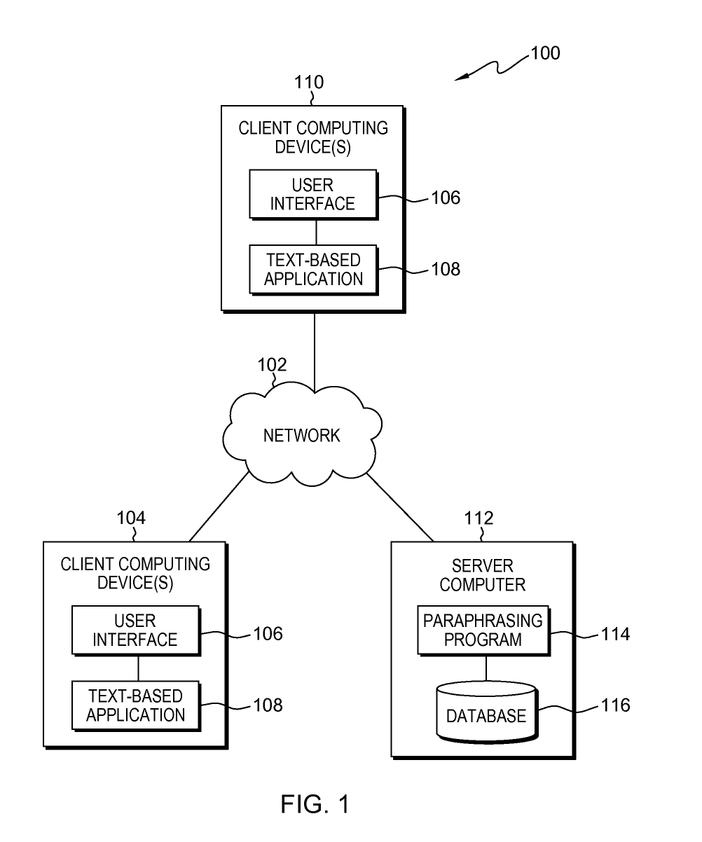

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes client computing device(s) 104, client computing device(s) 110, and server computer 112, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that are capable of receiving and transmitting data, voice, and/or video signals, including multimedia signals that include voice, data, and video information. In general, network 102 can be any combination of connections and protocols that will support communications between client computing device(s) 104, client computing device(s) 110, server computer 112, and other computing devices (not shown) within distributed data processing environment 100.

Client computing device(s) 104 and client computing device(s) 110 can each be at least one of a laptop computer, a tablet computer, a smart phone, or any programmable electronic device capable of communicating with various components and devices within distributed data processing environment 100, via network 102. Client computing device(s) 104 and client computing device(s) 110 can each be a wearable computer. Wearable computers are miniature electronic devices that may be worn by the bearer under, with or on top of clothing, as well as in glasses, hats, or other accessories. Wearable computers are especially useful for applications that require more complex computational support than just hardware coded logics. In one embodiment, client computing device(s) 104 and client computing device(s) 110 can each be an e-reader, i.e., a mobile device that is designed primarily for the purpose of reading digital e-books and periodicals. In general, client computing device(s) 104 and client computing device(s) 110 represent any programmable electronic device or combination of programmable electronic devices capable of executing machine readable program instructions and communicating with other computing devices (not shown) within distributed data processing environment 100 via a network, such as network 102. Client computing device(s) 104 and client computing device(s) 110 each includes user interface 106 and text-based application 108.

User interface 106 provides an interface between a user of client computing device(s) 104 and client computing device(s) 110 and server computer 112. In one embodiment, user interface 106 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In another embodiment, user interface 106 may also be mobile application software that provides an interface between a user of client computing device(s) 104 and client computing device(s) 110 and server computer 112. Mobile application software, or an “app,” is a computer program designed to run on smart phones, tablet computers and other mobile devices. User interface 106 enables client computing device(s) 104 and client computing device(s) 110 to provide access for server computer 112 to analyze a user's writing history via paraphrasing program 114.

Text-based application 108 is one or more of a plurality of software applications that include text-based communication. For example, text-based application 108 may include a display of text for a user to read, such as a digital book, a web-based article, a blog, a document, an image, an email, etc. In another example, text-based application 108 may enable a user to write text, such as in a blog, a document, an image, an email, etc. In yet another example, text-based application 108 may enable a user to record text by either audio or video recording, or both. In the depicted embodiment, text-based application 108 resides on client computing device(s) 104 and on client computing device(s) 110. In another embodiment, text-based application 108 may reside elsewhere in distributed data processing environment 100 provided the users of client computing device(s) 104 and client computing device(s) 110 can access text-based application 108 via network 102.

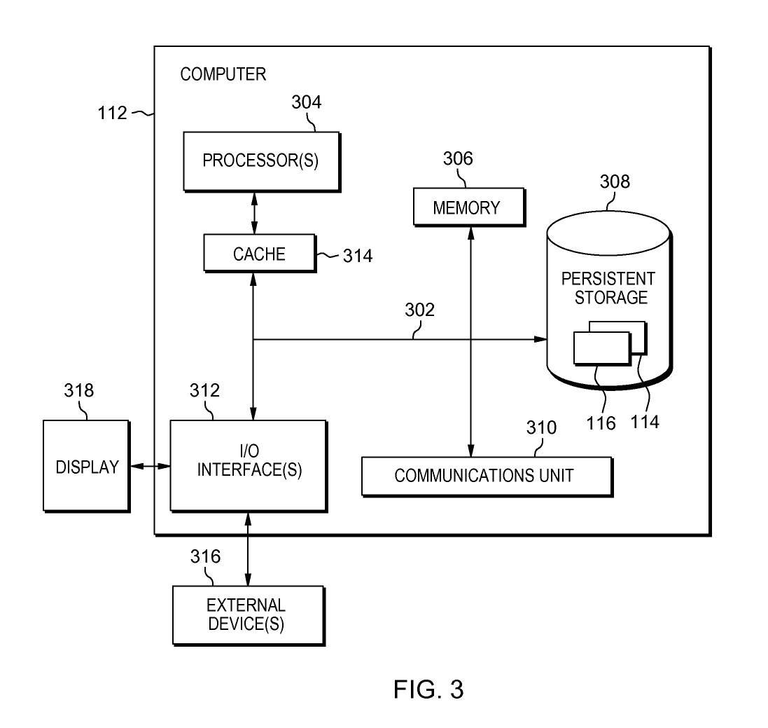

Server computer 112 can be a standalone computing device, a management server, a web server, a mobile computing device, or any other electronic device or computing system capable of receiving, sending, and processing data. In other embodiments, server computer 112 can represent a server computing system utilizing multiple computers as a server system, such as in a cloud computing environment. In another embodiment, server computer 112 can be a laptop computer, a tablet computer, a netbook computer, a personal computer (PC), a desktop computer, a personal digital assistant (PDA), a smart phone, or any programmable electronic device capable of communicating with client computing device(s) 104, client computing device(s) 110, and other computing devices (not shown) within distributed data processing environment 100 via network 102. In another embodiment, server computer 112 represents a computing system utilizing clustered computers and components (e.g., database server computers, application server computers, etc.) that act as a single pool of seamless resources when accessed within distributed data processing environment 100. Server computer 112 includes paraphrasing program 114 and database 116. Server computer 112 may include internal and external hardware components, as depicted and described in further detail with respect to FIG. 3.

In the depicted embodiment, paraphrasing program 114 resides on server computer 112. In another embodiment, paraphrasing program 114 may reside on client computing device(s) 104, or elsewhere within distributed data processing environment 100. Using text recognition analytics, paraphrasing program 114 analyzes the history of writing and/or speech recordings of a user to determine the user's preferred writing style, creates a personalized “dictionary” or profile, and stores the personalized dictionary in database 116. Paraphrasing program 114 reviews the user's text or speech inputs to text-based application 108 to capture the user's usage of words and phrases as well as the user's sentence formation. As used within this specification, the term “words” refers to more than one word. In one aspect, the term “words” can refer to two or more sequential words as in the case of a phrase. In another aspect, the term “words” can refer to non-sequential individual words as in the case of one or more words that are separated by one or more other intervening words or symbols. It should be appreciated that while operation of the one or more embodiments disclosed within this specification is described largely with reference to a word by word type of evaluation, a phrase level evaluation of text can be performed so that phrases (e.g., two or more consecutive words and/or symbols) can be analyzed and compared to a user's preferred writing style. Accordingly, reference to a word or words within this specification can include the processing of a phrase or phrases. The writing history of the user can include various electronic documents that the user has originated or written including, but not limited to, e-mail, blogs, articles, word processing documents, other text documents, web pages, or the like. In one embodiment, a user may electronically scan a handwritten document and the content of the hand written document may also be included in the user's writing history. In another embodiment, the writing history can include text derived from a user's speech in either an audio or video recording. In general, the writing history of the user includes electronic documents that include text that the user has authored. In another embodiment, paraphrasing program 114 may include a user's reading history to determine the user's preferred writing style. For example, if paraphrasing program 114 determines that a user re-reads a particular fiction book multiple times, then paraphrasing program 114 can determine that the user is comfortable with the writing style of the book, and the writing style of the book can be included in the user's preferred writing style and writing history.

In one embodiment, if client computing device(s) 104 do not include text-based application 108, or if the contents of text-based application 108 do not include sufficient text samples for paraphrasing program 114 to create a personalized dictionary, then paraphrasing program 114 can analyze writing and/or speech recordings of one or more users of client computing device(s) 110, who can be grouped with the user of client computing device(s) 104 via a commonality between the users, and create a personalized dictionary based on the group. For example, paraphrasing program 114 may consider users from a similar community or location as a group. In another example, paraphrasing program 114 may consider users with a similar educational background as a group. In yet another example, paraphrasing program 114 may consider users with a connection on a social network as a group. Paraphrasing program 114 can run analytics across the group and generate trends to determine a common preferred writing style of the group. In one embodiment, paraphrasing program 114 creates a group dictionary. In another embodiment, paraphrasing program 114 may refer to the individual personalized dictionaries of each person in the group. In one embodiment, paraphrasing program 114 updates the personalized dictionary each time the user accesses or adds content to text-based application 108. In another embodiment, paraphrasing program 114 updates the personalized dictionary on a regular time interval. In yet another embodiment, paraphrasing program 114 updates the personalized dictionary when the user, via user interface 106, prompts paraphrasing program 114 to make an update.

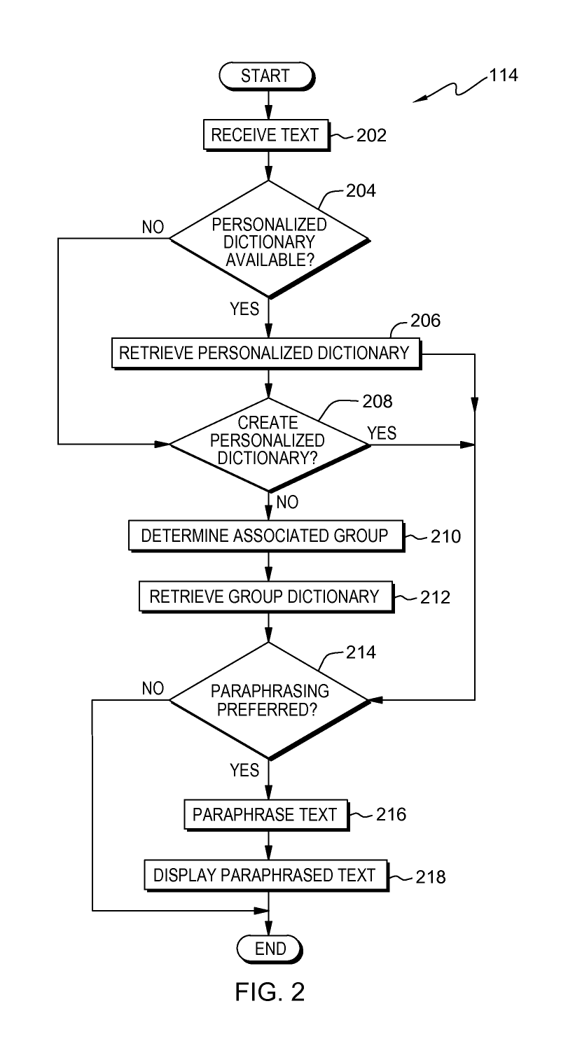

Once paraphrasing program 114 captures the user's preferred writing style in the personalized dictionary, paraphrasing program 114 analyzes any text presented to the user by text-based application 108 for the user to read, retrieves the user's personalized dictionary, or an associated group dictionary, and determines whether the user's reading comfort or speed can be improved by paraphrasing the text using words or phrases from the personalized dictionary. If paraphrasing program 114 determines the user's reading comfort can be improved by paraphrasing the text using the personalized dictionary, then paraphrasing program 114 paraphrases the text and displays the paraphrased text to the user. Paraphrasing program 114 is depicted and described in further detail with respect to FIG. 2.

In the depicted embodiment, database 116 resides on server computer 112. In another embodiment, database 116 may reside elsewhere within distributed data processing environment 100 provided paraphrasing program 114 has access to database 116. A database is an organized collection of data. Database 116 can be implemented with any type of storage device capable of storing data and configuration files that can be accessed and utilized by server computer 112, such as a database server, a hard disk drive, or a flash memory. Database 116 stores personalized dictionaries created by paraphrasing program 114. The stored personalized dictionaries may be for an individual user as well as for a group of users. In one embodiment, database 116 stores the writing, speaking, and/or reading history of the users of client computing device(s) 104 and client computing device(s) 110. In another embodiment, the writing, speaking, and/or reading history of the users of client computing device(s) 104 and client computing device(s) 110 are stored in one or more other storage devices within distributed data processing environment 100 (not shown).

FIG. 2 is a flowchart depicting operational steps of paraphrasing program 114, on server computer 112 within distributed data processing environment 100 of FIG. 1, for personalized paraphrasing of text, in accordance with an embodiment of the present invention.

Paraphrasing program 114 receives text (step 202). When a user of client computing device(s) 104 initiates text-based application 108, paraphrasing program 114 receives the text that text-based application 108 displays for the user to read. The displayed text may include, but is not limited to, a digital book, a web-based article, a blog, a document, an image, an email, a text message, etc.

Paraphrasing program 114 determines whether a personalized dictionary is available for the user (decision block 204). A personalized dictionary contains words, phrases, and sentence formations collected from the user's writing history, speaking history, and/or reading history. A personalized dictionary may also include contents such as synonyms for common words. A personalized dictionary may also include specifics of the user's preferred writing style, such as whether the user prefers an active voice to a passive voice. In one embodiment, paraphrasing program 114 determines whether a personalized dictionary for the user is stored in database 116 or elsewhere in distributed data processing environment 100.

If paraphrasing program 114 determines that a personalized dictionary is available (“yes” branch, decision block 204), then paraphrasing program 114 retrieves the personalized dictionary (step 206). If paraphrasing program 114 determines that a personalized dictionary is stored in database 116, then paraphrasing program 114 retrieves the personalized dictionary from database 116.

If paraphrasing program 114 determines that a personalized dictionary is not available (“no” branch, decision block 204), then paraphrasing program 114 determines whether a personalized dictionary can be created (decision block 208). Paraphrasing program 114 determines whether sufficient writing or speaking history is available, via network 102, to create a personalized dictionary for the user. In one embodiment, paraphrasing program 114 determines whether sufficient writing or speaking history is available based on a pre-defined threshold of text quantity. For example, a software developer may define a sufficient writing history threshold as the equivalent of ten paragraphs of text. In another example, a software developer may define a sufficient writing history threshold as samples of text from at least three different types of writing, such as a document, an email, and a blog. In another embodiment, the user may define the threshold for sufficient writing or speaking history, via user interface 106. In one embodiment, the personalized dictionary may be in the user's native language.

If paraphrasing program 114 determines that a personalized dictionary cannot be created (“no” branch, decision block 208), then paraphrasing program 114 determines an associated group (step 210). A user of client computing device(s) 104 may not be textually active enough, or may have strict privacy rules regarding data sharing, such that insufficient data exists for paraphrasing program 114 to analyze and derive patterns for paraphrasing. If insufficient writing history exists for paraphrasing program 114 to create a personalized user dictionary, then paraphrasing program 114 determines a group of one or more users of client computing device(s) 110 with which the first user, i.e., the user of client computing device(s) 104, shares one or more attributes. In one embodiment, a group includes at least two users of client computing device(s) 110. In another embodiment, paraphrasing program 114 includes a pre-defined threshold number of users of client computing device(s) 110 with common attributes to be considered a group. Common attributes which associate the group with the user may include, but are not limited to, age, occupation, education level, geographic location, community of origin, employer, school attended, family, etc. Paraphrasing program 114 may also determine an associated group as a group of users with which the user of client computing devices(s) shares a social network connection. Paraphrasing program 114 analyzes the content of the received text and determines an associated group. For example, if paraphrasing program 114 determines the content of the received text is relevant to an interest of the user, such as technology, then paraphrasing program 114 determines one or more users of client computing device(s) 110 with writing history corresponding to technology as an associated group. In another example, if paraphrasing program 114 determines the content of the received text is relevant to a particular community, then paraphrasing program 114 determines one or more users of client computing device(s) 110 with a connection to the community as an associated group. In an embodiment, if the received text is generic in nature, and paraphrasing program 114 cannot determine an associated group based on the content of the received text, then paraphrasing program 114 may determine an associated group based on textual activity level of a group. For example, paraphrasing program 114 may determine an associated group as a group of users of client computing device(s) 110 with more activity in emails, documents, and blogs than other groups. In another embodiment, a user may define a default group via user interface 106. In a further embodiment, a user may create a profile, via user interface 106, which paraphrasing program 114 stores in database 116 that lists attributes and interests with which paraphrasing program 114 can find commonality with other such user profiles, enabling paraphrasing program 114 to determine an associated group.

Responsive to determining one or more associated groups, paraphrasing program 114 retrieves a group dictionary (step 212). If paraphrasing program 114 determines that a group dictionary is stored in database 116, then paraphrasing program 114 retrieves the group dictionary from database 116. If paraphrasing program 114 determines that a group dictionary is not stored in database 116, then paraphrasing program 114 retrieves a group dictionary by analyzing the associated group's writing and speaking history and creating a personalized dictionary for the group. In one embodiment, if paraphrasing program 114 determines multiple associated groups in step 208, then paraphrasing program 114 may retrieve two or more group dictionaries and create a combination of group dictionaries. In another embodiment, if paraphrasing program 114 determines multiple associated groups in step 210, then paraphrasing program 114 may look for overlapping text or patterns between the group dictionaries. In a further embodiment, paraphrasing program 114 may refer to the individual personalized dictionaries of each person in the group.

Responsive to retrieving or creating either a personalized dictionary or a group dictionary, paraphrasing program 114 determines whether the user would prefer paraphrasing of the received text (decision block 214). Paraphrasing program 114 compares the received text to the retrieved dictionary and determines whether there are any words, phrases, or sentence formations within the received text that may be better understood by the user if paraphrased according to the user or group personalized dictionary. In one embodiment, paraphrasing program 114 may determine the received text may be better understood if paraphrased based on whether the number of words, phrases, or sentence formations that are not in the retrieved dictionary exceeds a pre-defined threshold. In another embodiment, paraphrasing program 114 may determine the received text may be better understood if paraphrased based on a threshold duration of time the user spends on a particular piece of text. In a further embodiment, a user may prompt paraphrasing program 114, via user interface 106, with a preference to paraphrase the text the user is reading. If paraphrasing program 114 determines that paraphrasing is not preferred (“no” branch, decision block 214), then paraphrasing program 114 ends.

If paraphrasing program 114 determines that paraphrasing is preferred (“yes” branch, decision block 214), then paraphrasing program 114 paraphrases the text (step 216). Paraphrasing program 114 replaces the words or phrases with which the user may be uncomfortable or unfamiliar with corresponding words or phrases from the retrieved personalized dictionary in order to help the user to better understand the text. For example, if the received text reads, “Her life spanned years of incredible change for women,” then paraphrasing program 114 may analyze the personalized dictionary for the words “spanned,” “incredible,” and “women,” and paraphrase the sentence as “Her life crossed years of unimaginable change for ladies.” Paraphrasing program 114 may also rearrange one or more sentences to a sentence formation the user is more likely to understand. For example, if the personalized dictionary indicates that the user understands an active voice better than a passive voice, then paraphrasing program 114 may re-phrase a sentence from “I was given a book by our Lecturer,” to “Our Lecturer gave me a book.” In one embodiment, paraphrasing program 114 may paraphrase the text as a direct translation from the original language in which the text is written to the user's native language.

Responsive to paraphrasing the received text, paraphrasing program 114 displays the paraphrased text to the user (step 218). Paraphrasing program 114 displays the paraphrased text on client computing device(s) 104, via user interface 106. In one embodiment, paraphrasing program 114 displays both the original text and the paraphrased text, with one version of the text in parentheses, such that the user is aware of the paraphrasing and may learn the unfamiliar words while reading the text. In another embodiment, paraphrasing program 114 displays only the paraphrased text such that the user can read the text seamlessly, without visual interruption. In one embodiment, client computing device(s) 104 is a wearable computing device in the form of glasses. In the embodiment, paraphrasing program 114 displays the paraphrased text in the lenses of the glasses such that the user sees the paraphrased text in the user's field of view. In one embodiment, paraphrasing program 114 displays the paraphrased text by receiving the original text as an image and converting the image to text. Then paraphrasing program 114 paraphrases the text, as discussed with respect to step 214, and converts the text back to an image. Paraphrasing program 114 then displays the new image in the glasses. In the embodiment, a user may wear the glasses to use paraphrasing program 114 with a hard copy book or other hand-held version of a book in addition to digital text content.

FIG. 3 depicts a block diagram of components of server computer 112 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 112 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., paraphrasing program 114 and database 116 are stored in persistent storage 308 for execution and/or access by one or more of the respective processor(s) 304 of server computer 112 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device(s) 104 and client computing device(s) 110. In these examples, communications unit 310 includes one or more network interface cards. Communications unit 310 may provide communications through the use of either or both physical and wireless communications links. Paraphrasing program 114 and database 116 may be downloaded to persistent storage 308 of server computer 112 through communications unit 310.

I/O interface(s) 312 allows for input and output of data with other devices that may be connected to server computer 112. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., paraphrasing program 114 and database 116 on server computer 112, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for paraphrasing text, the method comprising:
receiving, by a computing device, text as viewed by a first user;
determining, by the computing device, whether a personalized dictionary is available, wherein the personalized dictionary includes a writing history of the first user;
responsive to determining the personalized dictionary is available, retrieving, by the computing device, the personalized dictionary;
determining, by the computing device, based, at least in part, on the personalized dictionary, whether the first user prefers paraphrasing of the received text;
responsive to determining the first user prefers paraphrasing of the received text, determining, by the computing device, paraphrased text based on contents of the personalized dictionary; and
displaying, by the computing device, the paraphrased text to the first user.

2. The method of claim 1, wherein the computing device is a wearable computing device.

3. The method of claim 1, wherein the writing history includes one or more of: an e-mail, a blog, an article, a word processing document, a text document, a Web page, an electronically scanned handwritten document, a video recording of a user's speech, an audio recording of a user's speech, or a reading history.

4. The method of claim 1, further comprising:
responsive to determining the personalized dictionary is not available, analyzing, by the computing device, the first user's writing history;
determining, by the computing device, whether the first user's writing history is sufficient to create a personalized dictionary; and
responsive to determining the first user's writing history is sufficient to create a personalized dictionary, creating, by the computing device, a personalized dictionary for the first user, based on the first user's writing history.

5. The method of claim 4, further comprising:
responsive to determining the first user's writing history is not sufficient to create a personalized dictionary, determining, by the computing device, a group of users associated with the first user, wherein a group of users associated with the first user is a group of one or more users with which the first user shares one or more common attributes;
retrieving, by the computing device, a group dictionary, wherein the group dictionary includes a writing history of each of the one or more users of the group of users associated with the first user;
determining, by the computing device, based, at least in part, on the group dictionary, whether the first user prefers paraphrasing of the received text; and
responsive to determining the first user prefers paraphrasing of the received text, determining, by the computing device, paraphrased text based on contents of the group dictionary.

6. The method of claim 5, wherein the group dictionary includes a combination of one or more writing histories of one or more groups associated with the first user.

7. The method of claim 5, wherein retrieving the group dictionary further comprises:
analyzing, by the computing device, the group's writing and speaking history; and
creating, by the computing device, a personalized dictionary for the group.

8. The method of claim 5, wherein the one or more common attributes include one or more of: an age, an occupation, an education level, a geographic location, a community of origin, an employer, a school attended, a family, an interest, a social network connection, or a textual activity level.

9. A computer program product for paraphrasing text, the computer program product comprising:
one or more computer readable storage device and program instructions stored on the one or more computer readable storage device, the stored program instructions comprising:
program instructions to receive text as viewed by a first user;
program instructions to determine whether a personalized dictionary is available, wherein the personalized dictionary includes a writing history of the first user;
responsive to determining the personalized dictionary is available, program instructions to retrieve the personalized dictionary;
program instructions to determine, based, at least in part, on the personalized dictionary, whether the first user prefers paraphrasing of the received text;
responsive to determining the first user prefers paraphrasing of the received text, program instructions to determine paraphrased text based on contents of the personalized dictionary; and
program instructions to display the paraphrased text to the first user.

10. The computer program product of claim 9, wherein the writing history includes one or more of: an e-mail, a blog, an article, a word processing document, a text document, a Web page, an electronically scanned handwritten document, a video recording of a user's speech, an audio recording of a user's speech, or a reading history.

11. The computer program product of claim 9, the stored program instructions further comprising:
responsive to determining the personalized dictionary is not available, program instructions to analyze the first user's writing history;
program instructions to determine whether the first user's writing history is sufficient to create a personalized dictionary; and
responsive to determining the first user's writing history is sufficient to create a personalized dictionary, program instructions to create a personalized dictionary for the first user, based on the first user's writing history.

12. The computer program product of claim 11, the stored program instructions further comprising:
responsive to determining the first user's writing history is not sufficient to create a personalized dictionary, program instructions to determine a group of users associated with the first user, wherein a group of users associated with the first user is a group of one or more users with which the first user shares one or more common attributes;
program instructions to retrieve a group dictionary, wherein the group dictionary includes a writing history of each of the one or more users of the group of users associated with the first user;
program instructions to determine, based, at least in part, on the group dictionary, whether the first user prefers paraphrasing of the received text; and
responsive to determining the first user prefers paraphrasing of the received text, program instructions to determine paraphrased text based on contents of the group dictionary.

13. The computer program product of claim 12, wherein the group dictionary includes a combination of one or more writing histories of one or more groups associated with the first user.

14. The computer program product of claim 12, wherein the program instructions to retrieve the group dictionary comprise:
program instructions to analyze the group's writing and speaking history; and
program instructions to create a personalized dictionary for the group.

15. A computer system for paraphrasing text, the computer system comprising:
one or more computer processors;
one or more computer readable storage device;
program instructions stored on the one or more computer readable storage device for execution by at least one of the one or more computer processors, the stored program instructions comprising:
program instructions to receive text as viewed by a first user;
program instructions to determine whether a personalized dictionary is available, wherein the personalized dictionary includes a writing history of the first user;
responsive to determining the personalized dictionary is available, program instructions to retrieve the personalized dictionary;
program instructions to determine, based, at least in part, on the personalized dictionary, whether the first user prefers paraphrasing of the received text;
responsive to determining the first user prefers paraphrasing of the received text, program instructions to determine paraphrased text based on contents of the personalized dictionary; and
program instructions to display the paraphrased text to the first user.

16. The computer system of claim 15, wherein the one or more computer processors are included in a wearable computing device.

17. The computer system of claim 15, the stored program instructions further comprising:
responsive to determining the personalized dictionary is not available, program instructions to analyze the first user's writing history;
program instructions to determine whether the first user's writing history is sufficient to create a personalized dictionary; and
responsive to determining the first user's writing history is sufficient to create a personalized dictionary, program instructions to create a personalized dictionary for the first user, based on the first user's writing history.

18. The computer system of claim 17, the stored program instructions further comprising:
responsive to determining the first user's writing history is not sufficient to create a personalized dictionary, program instructions to determine a group of users associated with the first user, wherein a group of users associated with the first user is a group of one or more users with which the first user shares one or more common attributes;
program instructions to retrieve a group dictionary, wherein the group dictionary includes a writing history of each of the one or more users of the group of users associated with the first user;
program instructions to determine, based, at least in part, on the group dictionary, whether the first user prefers paraphrasing of the received text; and
responsive to determining the first user prefers paraphrasing of the received text, program instructions to determine paraphrased text based on contents of the group dictionary.

19. The computer system of claim 18, wherein the group dictionary includes a combination of one or more writing histories of one or more groups associated with the first user.

20. The computer system of claim 18, wherein the program instructions to retrieve the group dictionary comprise:
program instructions to analyze the group's writing and speaking history; and
program instructions to create a personalized dictionary for the group.
